(19) United States
(12) Patent Application Publication
(10) Pub. No.: US 2013/0267311 A1
(43) Pub. Date: Oct. 10, 2013

(54) IDENTITY GAME

(71) Applicant: Sai Kumar, Richardson, TX (US)

(72) Inventor: Sai Kumar, Richardson, TX (US)

(21) Appl. No.: 13/763,824

(22) Filed: Feb. 11, 2013

Related U.S. Application Data
(60) Provisional application No. 61/620,739, filed on Apr. 5, 2012.

(51) Int. Cl. A63F 13/00

(52) U.S. Cl. CPC A63F 13/00
USPC 463/31

(57) ABSTRACT

A game apparatus includes a media conversion engine configured to convert starting media having true component objects into converted media having identity-obscured component objects. A player interface of the game apparatus receives, from players, identity hypothesis information regarding the identity-obscured component objects and a hypothesis tester compares the identity hypothesis information with a true identity input and outputs feedback. Feedback output is presented to players through the player interface. A method for playing a game using the game apparatus is also included.

### CROSS REFERENCE TO RELATED APPLICATIONS

This application claims the priority benefit of U.S. Provisional Application No. 61/620,739 filed on Apr. 5, 2012 which is incorporated herein by reference in its entirety.

### BACKGROUND

Games have been played by people for thousands of years as a way to exercise body and mind, entertain, and educate. In recent decades, due to the wide availability of relatively inexpensive personal consumer electronics devices such as desktop computers, laptop computers, personal digital assistants, tablet computers and smartphones, there has been a proliferation of electronic games.

### SUMMARY

A game apparatus in accordance with embodiments of the disclosure includes a media conversion engine configured to convert starting media having true component objects into converted media having identity-obscured component objects, a player interface configured to receive identity hypothesis information regarding the identity-obscured component objects, a hypothesis tester configured to compare the identity hypothesis information with a true identity input and to output feedback to the player as well as a counter configured to record feedback accumulation.

A gaming method in accordance with embodiments of the disclosure includes converting starting media into converted media such that the identity of one or more objects depicted by the starting media is obscured in the converted media, inputting a true identity of the one or more objects, displaying the converted media to at least one player, prompting the player for an identity hypothesis about one or more objects in the converted media, receiving the identity hypothesis about the one or more objects, comparing the input identity hypothesis to the true identity of the object, providing the player with positive feedback when the input identity hypothesis is equal to the true identity of the object and providing the player with negative feedback when the input identity hypothesis does not equal the true identity of the object.

### BRIEF DESCRIPTION OF THE FIGURES

FIG. 1 illustrates an example schematic of an electronic computing device with installed computer readable game instructions in accordance with embodiments of the disclosure.

FIG. 2 illustrates an example schematic of a game engine installed on an electronic computing device in accordance with embodiments of the disclosure.

FIG. 3 illustrates an example set-up interface presenting starting media in the form of an image in accordance with embodiments of the disclosure.

FIG. 4 illustrates a first example of converted media in the form of an image in accordance with embodiments of the disclosure.

FIG. 5 illustrates a second example of converted media in the form of an image in accordance with embodiments of the disclosure.

FIG. 6 illustrates an example player interface presenting converted media in the form of an image in accordance with embodiments of the disclosure.

FIG. 7 illustrates an example player interface presenting starting media in the form of an image in accordance with embodiments of the disclosure.

FIG. 8 illustrates an example flow diagram of a method for converting media in accordance with embodiments of the disclosure.

FIG. 9 illustrates an example flow diagram of a method for playing a game in accordance with embodiments of the disclosure.

### DETAILED DESCRIPTION

For simplicity, the description of the features and processes of the game makes use of the term ‘media’. It should be noted that a game in accordance with the embodiments disclosed is not limited for use with one particular type of media but may be used with a variety of forms of media including, but not limited to, images and video.

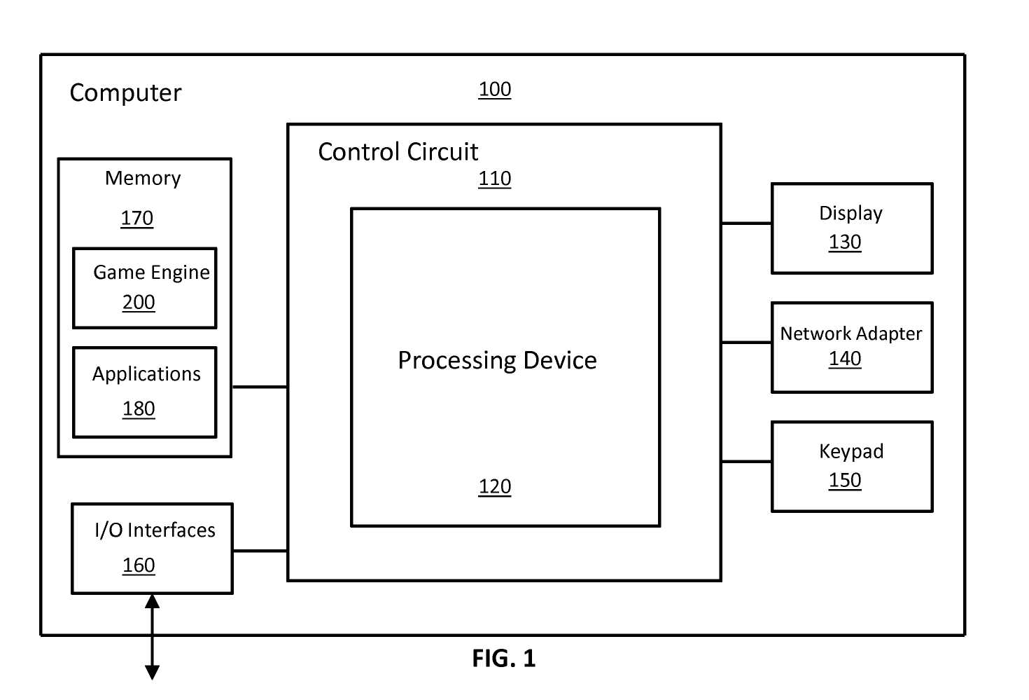

As shown in FIG. 1, the game engine 200 of an identity game apparatus may be implemented through the use of a computer or equivalent electronic computing device, generally indicated at 100, having a memory 170 configured to store game data, game media and game engine 200 in the form of computer readable game instructions. Computer 100 further includes a processing device 120 for executing instructions encoded within game engine 200 as well as input/output interfaces 160 for receiving instructions from processing device 120 to provide output to external devices such as display 130 or receive input from external devices such as keypad 150.

The computer 100 may be any device capable of executing computer readable program code stored in memory 170 including by not limited to a desktop computer, a laptop computer, a tablet computer, a personal digital assistant or a smartphone. In some embodiments, the computing device is one that is readily transported by the user to enable a user to play the identity game wherever the user goes. In some embodiments, the computer may be a component of a digital camera and game engine 200 may operate directly on the digital camera.

As memory 170, any combination of one or more computer readable mediums may be used. The computer readable medium may be a computer readable storage medium or a computer readable signal medium.

Computer readable storage mediums usable within the computer 100 may include but are not limited to electronic, magnetic, optical, electromagnetic, infrared, or semiconductor systems, apparatuses, or devices, or any suitable combination thereof. Specific examples include but are not limited to electrical connections having one or more wires; portable computer diskettes; hard disks; random access memories (RAM); read-only memories (ROM); erasable, programmable read-only memories (EPROM or Flash memory); optical fibers; portable compact disc read-only memories (CD-ROM); optical storage devices; magnetic storage devices; and combinations thereof. In the context of this disclosure, a computer readable storage medium may be any tangible, non-transitory medium capable of containing, or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical or a combination thereof. A computer readable signal medium may be any computer readable medium that is not a computer readable storage medium and that can communicate, propagate, or transport a program for use by or in connection with an instruction execution system, apparatus, or device.

Further, program code embodied on a computer readable medium may be transmitted using any appropriate medium, including but not limited to wireless, wireline, optical fiber cable, RF or any combination of these.

Computer program code included within game engine 200 and capable of carrying out operations for aspects of the identity game may be written in any combination of one or more programming languages, including an object oriented programming language such as Java, Smalltalk, C++ or the like and conventional procedural programming languages, such as the “C” programming language or similar programming languages. The program code may execute entirely on the users computing device system, partly on the users computing device system, or entirely on a remote computer or server connected to the user's computing device system through any type of network, including a local area network (LAN) or a wide area network (WAN). Alternatively, the connection may be made to an external computing device system through the Internet using an Internet Service Provider.

Input/output interfaces 160 may include but are not limited to keyboards, pointing devices, gesture interpreting devices, touchscreens and other displays, printers, and audio speakers which are capable of operative coupling to the computer 100 either directly or through intervening I/O.

In some embodiments, I/O interfaces 160 of computer 100 may further include software, hardware, etc. for transmitting and receiving information according to the mobile phone mobile communications standards 3G or 4G. For example, the computer 100 may enable UMTS, mobile WiMAX, Long Term Evolution, CDMA200, W-CDMA and TD-SCDMA.

In some embodiments, the computer 100 is capable, through various I/O interfaces, to provide media information to a display remote from computer 100.

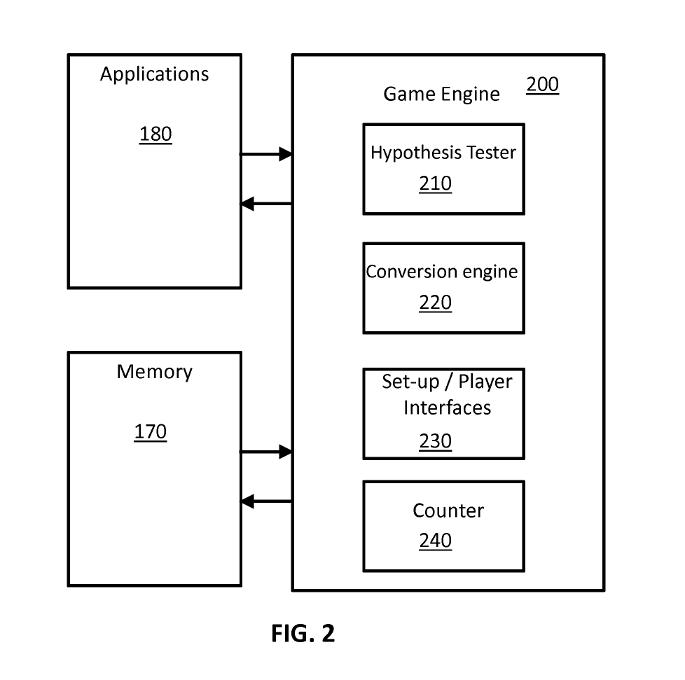

As shown by way of example in FIG. 2, the game engine 200 includes a number of components for performing tasks to manage use of a game apparatus in accordance with embodiments of the disclosure. The game engine may generally delegate actions to one or more of the various components in accordance with user input and criteria pre-programmed as, for example, instructions executable by computer 100. While depicted as being operatively coupled with memory 170 and application 180, game engine 200 may be operatively coupled with either of these and not the other and/or may be coupled directly with processing device 120.

It should be understood that each component illustrated in FIG. 2, and combinations thereof are capable of implementation by computer readable program code in the form of instructions. These instructions may be provided to a processing device 120 which may be a component of a general purpose computing device system, special purpose computing device system, or other programmable data processing apparatus to produce a machine, such that the instructions, which execute via processing device 120 of computer 100 or other programmable data processing apparatus, create means for implementing functions of the components.

The computer readable program code in the form of instructions may also be stored in a computer readable medium that can direct a computing device system or other programmable data processing apparatus such that the instructions produce an article of manufacture including instructions which implement functions components.

Game engine 200 interacts with memory 170 and applications 180 to facilitate delivery of a game experience to one or more game players and includes a hypothesis tester 210 configured to determine the veracity of input from one or more game players, a conversion engine 220 configured to convert starting media into converted media, set-up/player interfaces 230 and counter 240 configured to count accumulating player feedback. In some embodiments, various components of game engine 200 may be combined or eliminated.

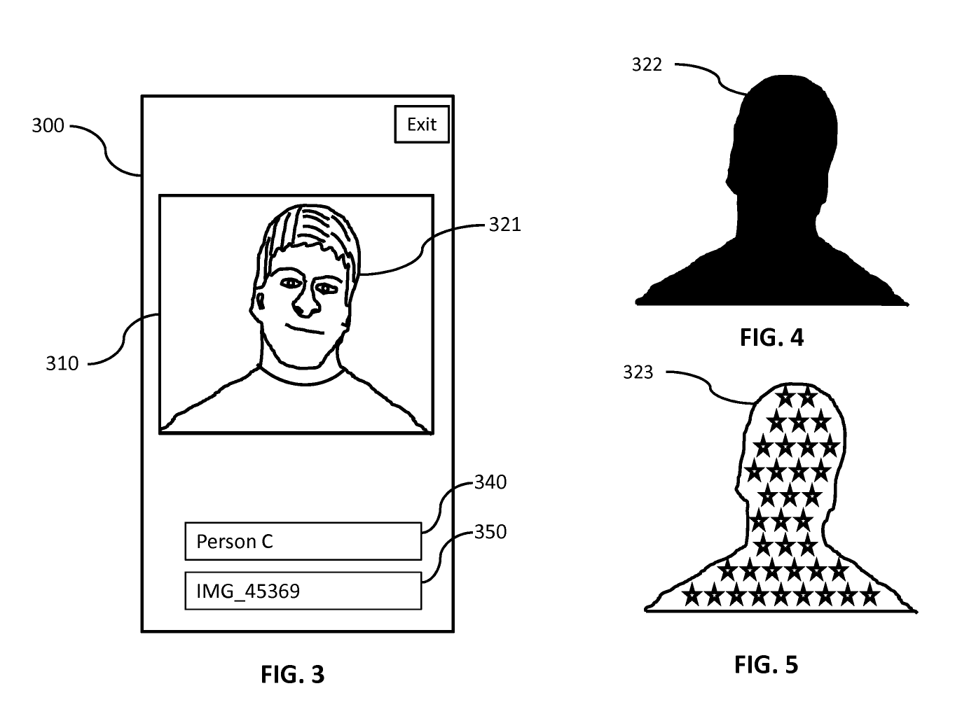

Computer readable game instructions in the form of a game engine 200 stored in the computer readable memory component 170 cause the computer 100 to recruit set-up/player interfaces 230 to provide a set-up interface to display 130 of electronic computing device 100. An example set-up interface 300 as illustrated in FIG. 3 may comprise an media input receptacle 350 and true identity input receptacle 340 to display and receive starting media input and true identity input from the at least one input 160 of computer 100.

Game engine 200 also includes a media conversion engine 220 configured to convert starting media such as a starting image 310 having a true component object 321 into converted media having a silhouette or shadow component object 322 with an obscured identity. Media conversion engine 220 may operate according to a number of known methods for converting portions of images into silhouette or shadows. For example, the engine may establish a distinction between the edge of an object and the surroundings to determine an object outline. The object outline may be subsequently filled by replacement content of various forms to obscure the identity of the object. While depicted as a person, component objects are not limited to persons but may also include animals, objects, buildings, geographical features, etc.

Some embodiments may permit a user to set how an object outline is filled. For example, the object outline may be filled in as a solid color as with the object 322 illustrated in FIG. 4 or as a pattern as with the object 323 illustrated in FIG. 5. Solid color fills may include but are not limited to black, red, blue, yellow, etc., while patterns may include simple patterns such as cross-hatching or repeated shapes like stars or may include more complex patterns. Some embodiments enable filling the object with other media such as images, video or text as long as the object identity is obscured in the converted media. For example, a starting image or video may include object portions not removed from within the outline such as a person's clothing.

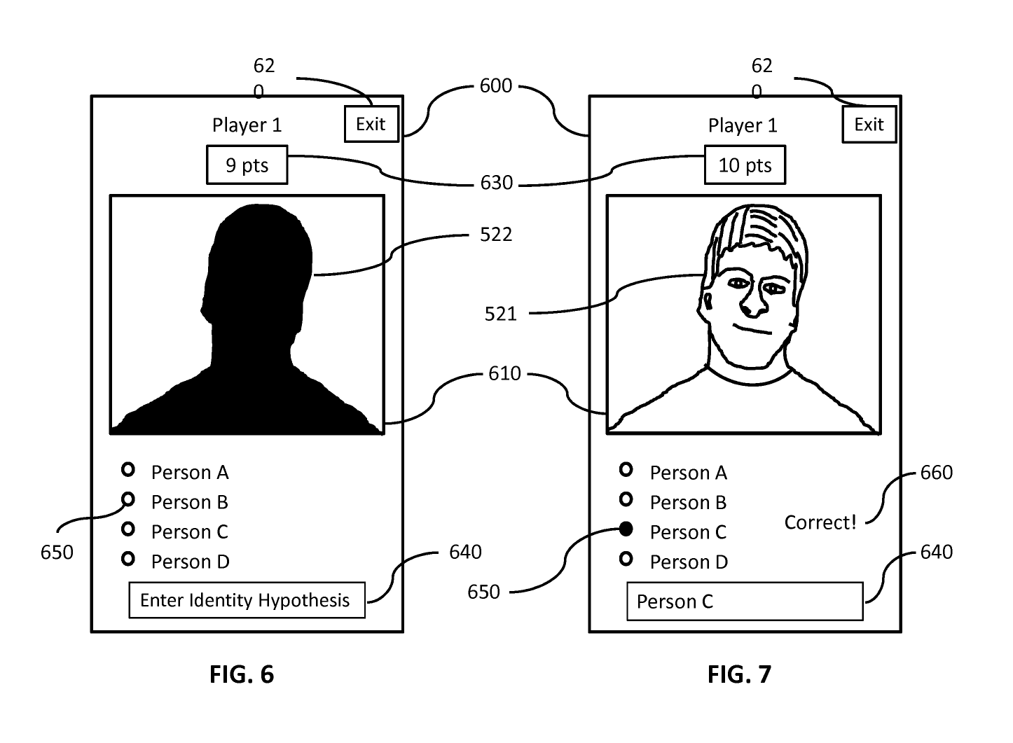

Computer readable game instructions in the form of a game engine 200 stored in the computer readable memory component 170 cause the computer 100 to provide a player interface to display 130 of electronic computing device 100. An example player interface 600 as illustrated in FIGS. 6 and 7 may comprise one or more media displays 610, identity hypothesis input receptacles 640, 650 and feedback displays 630, 660. With reference to FIG. 6, input receptacles may be in the form of a plurality of virtual buttons 650 displayed within player interface 600 or in the form of a text input box 640 fillable by use of one or more input devices which may include but are not limited to hardware or virtual mice or pointers and hardware or virtual keyboards.

An identity hypothesis input entered into identity hypothesis receptacle 640, 650 may be provided to hypothesis tester 210 for comparison to the true identity input established during set-up using set-up interface 500. If hypothesis tester 210 determines the identity hypothesis input matches the true identity, positive feedback is output to player interface 600 at one or more feedback displays 630, 660. Feedback display 630 presents the player with the number of points the player has earned during the game. As illustrated in FIG. 6, feedback display 630 presents the player with a score of 9 points. As illustrated in FIG. 7, since Player 1 entered an identity hypothesis matching the true identity corresponding with the converted image 522, feedback display 630 indicates Player 1 has earned an additional point for a new total of 10 points.

If hypothesis tester 210 determines the identity hypothesis input does not match the true identity, negative feedback is output to player interface 600 at one or more feedback displays 630, 660. For example, feedback display 630 will not reflect the addition of a point to a player's total and feedback display 660 will not reflect positive feedback. In some embodiments, feedback display 630 may reflect subtraction of a point from a players total and feedback display 660 may reflect negative feedback.

It should be noted that a game according to embodiments of the present disclosure may use any of a variety of point systems. For example, a player proposing a matching identity hypothesis may earn 5 points, 10 points, 15 points, etc. and, in some embodiments, different media are associated with different point values according to an established level of difficulty. Feedback display 660 may display a positive feedback message to the player. In some embodiments, either or both of feedback displays 630 and 660 may be eliminated and feedback may be provided by other players and participants or a game manager.

Game engine 200 also includes counter 240 configured to record accumulating player feedback in memory 170. In embodiments which include a point system as player feedback, counter 240 adjusts an accumulated total of player points according to matching and lack of matching between identity hypotheses and true identities. The counter 240 is operatively coupled to receive player feedback from the hypothesis tester 220 and provide player feedback to feedback display 630 in the form of accumulated points. Game engine 200 associates player feedback with particular players and stores the game data to memory 170 in, for example, a database (not illustrated).

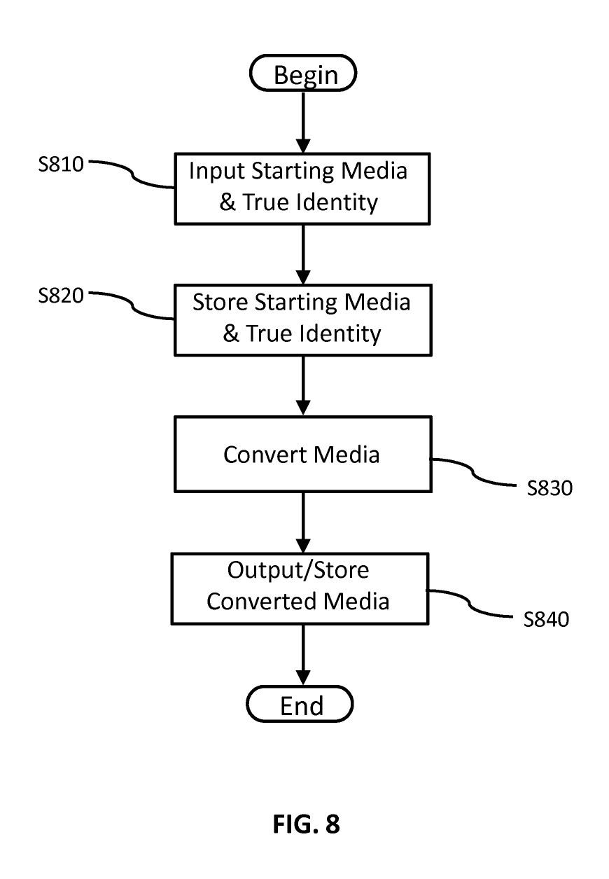

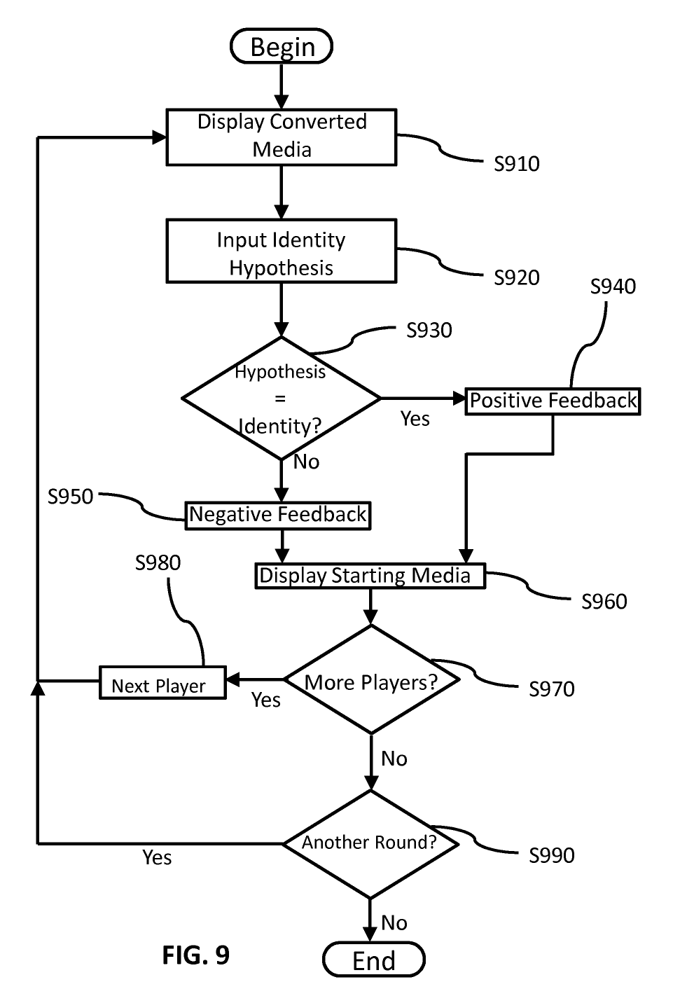

Processes of the game apparatus as well as a method of playing an identity game using the game apparatus will now be described with reference to FIGS. 8 and 9.

To provide a game in accordance with the embodiments disclosed, starting media is provided to a media conversion engine in step S810 and converted in a step S830 to yield converted media wherein the identity of one or more objects depicted by the starting media is obscured in the converted media. In some embodiments, a user may input previously recorded media to the computer 100 and select to have the media converted. In other embodiments, a user may record the media using a computer 100 operatively coupled with, including or included within a camera such as a digital camera or a digital video camera capable of recording media directly.

Either at the time of inputting previously recorded media or at the time of direct recording of media, the user, through use of a set-up interface 300 inputs the identity of one or more objects in the media. In step S820, the true identity is stored to memory 170 and in association with the object it identifies in the converted and starting media. In some embodiments, input of the true identity is accomplished through a known process of tagging the media such as images and video.

After conversion from the starting media, the converted media may be stored in memory 170 in association with the true identity input according to step S840. Game engine 200 may associate converted media with true identity input in, for example, a database.

In some embodiments, step S840 may provide for immediate output of converted media without storing in memory 170.

In some embodiments in which some or all of game engine 200 is installed directly into a memory of an electronic digital camera, instead of inputting media through use of set-up interface, the digital camera may convert media at the time of recording. This may be accomplished, for example, by setting the digital camera into a particular identity game or silhouette or shadow mode. In these embodiments, a set-up interface may still provide for associating a true identity of objects in the converted media with the converted media and/or the starting media. Alternatively, a user may be presented with a set-up interface upon selecting a virtual button while in a media recording mode.

Once one or more starting media have been converted, objects therein have been associated with true identities, and information identifying one or more players has been entered for association with a corresponding one or more player interfaces during play, game play may begin. In a step S910, media is displayed and a first player is prompted for an identity hypothesis about the identity of one or more objects in the converted media in step S920. In some embodiments, step S910 may include displaying the converted media to a large display remote from computer 100. For example, a group of players participating in the game may broadcast converted media stored on memories 170 of one or more computers 100 to a large display (not illustrated) viewable by all participating players. In this way, a large number of players may all easily view both converted and starting media.

After viewing the displayed media, the first player inputs an identity hypothesis in step S920. The identity hypothesis is received by game engine 200 and provided to hypothesis tester 210.

In step S930, hypothesis tester 210 determines whether the input hypothesis matches the true identity associated with the object during set-up. If the input hypothesis matches the true identity, positive feedback is presented to the player through player interface 600 according to step S940. As described above, positive feedback may include, but is not limited to, positive messages and crediting of points to the player and presenting a new accumulated point total.

If the input hypothesis does not match the true identity, negative feedback is presented to the player through player interface 600 according to step S450. Negative feedback may include but is not limited to negative messages and crediting of negative points to the player and presenting a new accumulated point total.

The game displays the starting media (300, for example) in a step S960. In some embodiments, one or both of the explicit positive S940 and negative S950 feedback steps may be eliminated such that displaying the starting media in step S960 provides both positive and negative feedback to players. These embodiments may or may not implement a point system. In other embodiments, the starting media may not be displayed to any game players until one of the players provides an identity hypothesis matching the true identity of an object in the converted and starting media.

In step S970, the game determines if there are more players. If there are more players, the game advances to the next player in step S980 and begins to display new converted media. In some embodiments, the number of players is provided to game engine 200 before the first player proposes an identity hypothesis, while in other embodiments, the number of players may be updated during game play.

If there are no more players, the game determines if the one or more players will play another round according to step S990. In some embodiments, game engine 200 makes this determination according to input from the one or more players while in other embodiments, game engine 200 makes this determination according to a pre-defined number of rounds required to complete one game.

If another round is to be played, new converted media is displayed to the starting player through player interface 600 in accordance with step S910 and the game proceeds through the appropriate steps from among S920-S990. If no more rounds are to be played, the game ends.

Upon ending of the game, a winner status is preferably awarded to the player having the highest accumulation of points or other positive feedback at the game end. In some embodiments, additional positive feedback is provided to the winner accordance with the earned winner status.

A game in accordance with embodiments of the present disclosure may be concluded at any step of the process described with reference to FIG. 9. Furthermore, less than all the active players may choose to conclude their game participation. The game process may be so concluded by providing corresponding input to the game engine. For example, a player may select virtual exit button 620 provided on player interface 600.

The processes and steps depicted by way of example in the flowchart illustrations of FIGS. 8 and 9 may be implemented by a computing device system or other programmable data processing apparatus interpreting and executing instructions stored as computer readable program code on one or more computer readable storage mediums or one or more computer readable signal mediums. Each block in the flowchart illustrations may represent a module, segment, or portion of computer readable program code, which comprises one or more executable instructions for implementing the depicted logical function(s). It should also be noted that, in some alternative implementations, the functions noted in the block may occur out of the order noted in the flowchart illustrations. For example, two blocks shown in succession may, in fact, be executed substantially concurrently, or the blocks may sometimes be executed in the reverse order, depending upon the functionality involved. It should also be noted that each block of the flowchart illustrations, can be implemented by special purpose hardware-based systems that perform the specified functions or acts, or combinations of special purpose hardware and computer executable instructions.

While embodiments of the game have been described as being for use with a computer 100, in some embodiments, the game may be played manually and without a computer 100. For example, a person setting up a game may copy starting media and manually convert one copy of the starting media into a converted media such that the identities of objects in the media are obscured. True identities of object in the media may then be physically recorded or the person setting up a game may hold the identities in his or her mind. During game play, one or more players are prompted to hypothesize about the identity of one or more objects in the converted media. The hypotheses are compared with the true identities and positive and negative feedback are provided, as appropriate. In these embodiments, feedback positive feedback may be provided in the form of simple praise while negative feedback may be provided in the form of scolding or admonishment. Accumulating point totals may be recorded, for example, on a piece of paper, a dry-erase or chalkboard or simply noted mentally. The game ends when one or more players or a game manager end the game. A winner may or may not be declared in these embodiments.

While the disclosure has been presented with respect to certain specific embodiments, it will be appreciated that many modifications and changes may be made by those skilled in the art without departing from the spirit and scope of the invention. It is intended, therefore, by the appended claims to cover all such modifications and changes as fall within the true spirit and scope of the invention.

What is claimed is:

1. A game apparatus, comprising:
a computer including a computer readable memory component configured to store computer readable game instructions and game data, a processor configured to process stored instructions and data, at least one input, and at least one output;
wherein computer readable game instructions stored in the computer readable memory component cause the computer to:
provide a set-up interface configured to present image input receptacles and true identity input receptacles to the at least one output and to receive starting image input and true identity input from the at least one input;
provide an image conversion engine configured to convert starting images having true component objects into converted images having silhouette component objects;
provide a player interface configured to present media displays, identity hypothesis input receptacles and feedback displays to the at least one output and to receive an identity hypothesis from the at least one input;
provide a hypothesis tester configured to compare an identity hypothesis input with a true identity input and to output player feedback to the feedback displays; and
provide a feedback counter configured to record accumulating player feedback in the memory component.

2. A game apparatus, comprising:
a media conversion engine configured to convert starting media having true component objects into converted media having identity-obscured component objects;
a player interface configured to receive identity hypothesis information regarding the identity-obscured component objects;
a hypothesis tester configured to compare the identity hypothesis information with a true identity input and output feedback to the player; and
a counter configured to record feedback accumulation.

3. The game apparatus as set forth in claim 2, wherein:
the player interface further comprises: media displays, identity hypothesis input receptacles and feedback presenters.

4. The game apparatus as set forth in of claim 2, further comprising:
a set-up interface having media input receptacles and true identity input receptacles.

5. The game apparatus as set forth in claim 2, wherein:
the game apparatus is configured to record the starting media.

6. The game apparatus as set forth in claim 2, wherein:
the media conversion engine is an image or video conversion engine and is configured to convert a starting image or video into a converted image or video.

7. The game apparatus as set forth in of claim 6, further comprising:
instructions for playing a game using the apparatus, wherein the instructions include a description of actions including viewing a converted image, guessing an identity of an object represented in the converted image or video, comparing guess to a true identity of the object, issuing negative feedback if the guess is wrong, issuing positive feedback if the guess is right.

8. The game apparatus as set forth in claim 7, further comprising:
a camera configured to record starting images or video for conversion into converted image or video.

9. The game apparatus as set forth in claim 7, further comprising:
a display configured to display the converted image or video.

10. A gaming method, comprising:
converting starting media into converted media such that the identity of one or more objects depicted by the starting media is obscured in the converted media;
inputting a true identity of the one or more objects;
displaying the converted media to at least one player;
prompting the player for an identity hypothesis input about one or more objects in the converted media;
receiving the identity hypothesis input about the one or more objects;
comparing the identity hypothesis input to the true identity of the object;
providing the player with positive feedback when the identity hypothesis input is equal to the true identity of the object; and
providing the player with negative feedback when the identity hypothesis input does not equal the true identity of the object.

11. The gaming method as set forth in claim 10, wherein:
processing starting media is performed using an electronic computing device.

12. The gaming method as set forth in claim 10, further comprising:
inputting the starting media to the electronic computing device.

13. The gaming method as set forth in claim 10, further comprising:
recording the starting media with the electronic computing device.

14. The gaming method as set forth in claim 13, wherein:
converting the starting media into converted media such that the identity of one or more objects depicted by the starting media is obscured in the converted media includes converting the starting media in the camera after recording the starting media.

15. The gaming method as set forth in claim 10, wherein:
the one or more objects are represented in the converted media as silhouettes.

16. The gaming method as set forth in claim 10, further comprising:
recording accumulation of the positive and negative feedback for each of a plurality of players.

17. The gaming method as set forth in claim 16, further comprising:
awarding a winner status to a player having the highest accumulation of positive feedback.
